(19) United States
(12) Patent Application Publication
(10) Pub. No.: US 2026/0015177 A1
(43) Pub. Date: Jan. 15, 2026

(54) MULTI-PURPOSE PICK CARTS FOR USE AT PRODUCT STORAGE FACILITIES

(71) Applicant: Symbotic LLC, Wilmington, MA (US)

(72) Inventors: William J. Fosnight, Windham, NH (US); Devin W. Rochelle, West Boylston, MA (US); Alan J. Grant, Nashua, NH (US); Julian D. Warhurst, Portsmouth, RI (US)

(21) Appl. No.: 19/268,463

(22) Filed: Jul. 14, 2025

Related U.S. Application Data
(60) Provisional application No. 63/671,437, filed on Jul. 15, 2024.

(51) Int. Cl. B65G 1/137; B60H 1/00; B65G 1/04; F25D 11/02

(52) U.S. Cl. CPC B65G 1/1375; B60H 1/00735; B65G 1/0492; F25D 11/02

(57) ABSTRACT

A cart, for transporting a plurality of items at a product storage facility, is provided. The cart includes: a frame; wheels mounted to and supporting the frame; at least one support member mounted to the frame and configured to support ambient-temperature items thereon; a refrigerator compartment mounted to at least one of the frame and the at least one support member and configured to store chilled items therein; and a freezer compartment mounted to at least one of the frame and the at least one support member and configured to store frozen items therein.

### CROSS-REFERENCE TO RELATED APPLICATIONS

This application is a non-provisional of and claim the benefit of U.S. provisional patent application No. 63/671,437 filed on Jul. 15, 2024, the disclosure of which is incorporated herein by reference in its entirety.

### BACKGROUND

### 1. Field

This disclosure relates generally to transporting products at a product storage facility, more specifically, to picking items for product orders to bags for customers and transporting the items.

### 2. Brief Description of Related Developments

An order fulfillment system, such for a retail store, warehouse, or distribution center, may fulfill customer orders for individual products or goods. Conventional order fulfillment may include retrieving inventory, stored in totes, from storage with mobile robots, where the mobile robots transport the totes to a picking station. Individual items of inventory are removed from the totes by a picker and placed in a container, such as a bag or box, for transport within the facility and ultimately to a customer.

Accordingly, the present disclosure addresses a number of those issues.

### BRIEF DESCRIPTION OF THE DRAWINGS

The foregoing aspects and other features of the present disclosure are explained in the following description, taken in connection with the accompanying drawings, wherein:

FIG. 1 is an exemplary perspective view illustration of an exemplary pick cart in accordance with the present disclosure;

FIG. 2 is an exemplary perspective view illustration of an automated product storage facility, incorporating the pick cart of FIG. 1, in accordance with the present disclosure;

FIG. 3 is an exemplary perspective view illustration of an automated product storage facility showing a product pickup area in accordance with the present disclosure;

FIG. 4 is an exemplary schematic illustration of a computing system of the product storage facility of FIGS. 2 and 3 in accordance with the present disclosure;

FIG. 5 is an exemplary schematic illustration of a computing system of the product storage facility of FIGS. 2 and 3 in accordance with the present disclosure;

FIG. 6 is an exemplary schematic illustration of a portion of a robotic transport unit of the automated product storage facility of FIGS. 2 and 3 in accordance with the present disclosure; and

FIG. 7 is an exemplary flow diagram of a method in accordance with the present disclosure.

### DETAILED DESCRIPTION

The following detailed description is meant to assist the understanding of one skilled in the art, and is not intended in any way to unduly limit claims connected or related to the present disclosure.

The following detailed description references various figures, where like reference numbers refer to like components and features across various figures, whether specific figures are referenced, or not.

The word “each” as used herein refers to a single object (i.e., the object) in the case of a single object or each object in the case of multiple objects. The words “a,” “an,” and “the” as used herein are inclusive of “at least one” and “one or more” so as not to limit the object being referred to as being in its “singular” form.

The terms “substantially” and “about” as may be used herein refer to a feature that may be varied within an acceptable manufacturing tolerance for a given application.

Reference throughout this specification to “one embodiment,” “an embodiment,” “some embodiments”, “an implementation”, “some implementations”, “some applications”, or similar language means that a particular feature, structure, or characteristic described in connection with the embodiment is included in at least one embodiment of the invention. Thus, appearances of the phrases “in one embodiment,” “in an embodiment,” “in some embodiments”, “in some implementations”, and similar language throughout this specification may, but do not necessarily, all refer to the same embodiment.

Spatial terms such as “left,” “right,” “top” and “bottom,” “upper,” and “lower,” front,” “back,” “vertical,” and “horizontal” as may be used herein are by way of example and illustrative purposes only and are not meant to limit the description and may be exchanged in position and orientation.

As used herein, the terms “substantially” and/or “about” mean that the specified dimension or parameter may be varied within an acceptable manufacturing tolerance for a given application. In one non-limiting embodiment, the acceptable manufacturing tolerance is ±0.25%.

For purposes of this disclosure, a connection may be a direct connection or an indirect connection (e.g., via one or more other parts). In some cases, when a first element is referred to as being connected, affixed or coupled to a second element, the first and second elements may be directly connected, affixed or coupled to each other or indirectly connected, affixed, or coupled to each other. When a first element is referred to as being directly connected, affixed, or coupled to a second element, then there are no intervening elements between the first and second elements (other than possibly an adhesive or weld used to connect, affix, or couple the first and second elements).

The present disclosure is described herein with reference to the figures, which in general relate to carts (also referred to herein as “pick carts”) for transporting products (e.g., bagged or unbagged products), which may be used with an automatic storage and retrieval system. As will be described in more detail below, the carts described herein enable efficient transportation of ambient, chilled, frozen products at a retail facility.

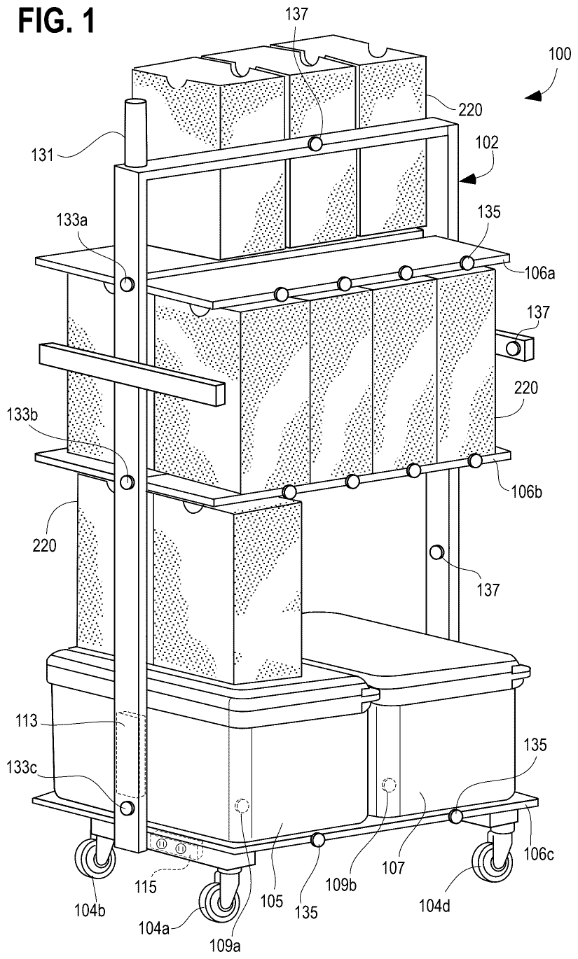

FIG. 1 shows an exemplary pick cart 100 for transporting bags 220 at a product storage facility. The pick cart 100 includes a frame 102 and wheels 104a-104d mounted to and supporting the frame 102. The exemplary pick cart 100 includes three support members 106 (e.g., a top support member 106a, a middle support member 106b, and a bottom support member 106c as shown in FIG. 1) mounted relative to the frame 102. The support members 106a-106c may be shelves, trays, or the like having a support surface that supports various items (which may be bagged or not bagged) thereon. A support member 106 may be sized and shaped to support four vertically oriented bags 220 containing one or more items placed into each of the bags 220 (see, e.g., FIGS. 1-3) although, one or more support member (e.g., shelf or tray) 106a-106c may be sized and shaped to support less than four or more than four vertically oriented bags 220 thereon.

As shown in FIG. 1, the cart 100 includes a first, temperature-controlled, storage compartment 105 (e.g., a refrigerator compartment, cooler compartment, etc.), which is non-detachably or detachably) mounted to the frame 102 and/or to the bottom support member 106c, and a second, temperature-controlled, storage compartment 107 (e.g., freezer, etc.), which is non-detachably or detachably) mounted to the frame 102 and/or to the bottom support member 106c. In FIG. 1, the refrigerator compartment 105 is shown on the left of the freezer compartment 107, and both the refrigerator and freezer compartments 105, 107 are shown as being located at the bottom shelf 106c of the cart 100 for exemplary purposes only. The refrigerator and freezer compartments 105, 107 may be located at the bottom shelf 106c of the cart 100, one or more bags 220 may be placed and stored directly on top (e.g., on the openable cover) of the refrigerator compartment 105 and/or the freezer compartment 107 as shown in FIG. 1.

It will be appreciated that the illustrated locations of the support members (e.g., shelves) 106a-106c and first and second storage compartments 105, 107 are shown by way of example only, and may be different (e.g., the pick cart 100 may include less than three (e.g., one or two) or more than three (four, five, six, etc.) support members 106, and two or more first and/or second compartments 105, 107, which may be located on the bottom support member (e.g., shelf) 106c and/or middle support member (e.g., shelf) 106b and/or top support member (e.g., shelf) 106a of the cart 100). The support members 106a-106c may be movably (e.g., pivotally) coupled relative to the frame 102, such that each of the support members 106a-106c is permitted to independently pivot upwardly and/or downwardly relative to the frame 102 of the cart 100.

Each of the support members 106a-106c may be permitted to fold up relative to the frame 102 from a horizontal position shown in FIG. 1 to a vertical position, and to fold back down relative to the frame 102 from the vertical position back to the horizontal position shown in FIG. 1. Such shelf configurations of pick carts are described, for example, in U.S. Provisional Patent App. No. 63/602,225, filed Nov. 22, 2023, and entitled “Direct to Bag Pick Carts for Use at Product Storage Facilities,” which is hereby incorporated by reference in its entirety. The support members 106a-106c may be fixedly coupled relative to the frame 102, such that the support members 106a-106c are not permitted to move relative to the frame 102.

Each of the first storage compartment 105 and second storage compartment 107 may a temperature sensor 109a and 109b, respectively. Each of the first and second storage compartments 105, 107 may be configured to be switchable (e.g., by a control signal, manual switch, etc.) between an active mode (where the first and second storage compartments 105, 107 actively cool their respective interiors) and a standby mode (where the first and second storage compartments 105, 107 do not actively cool their respective interiors).

When a temperature sensor 109a or 109b detects that the temperature in an interior of a respective one of the first and second storage compartments 105, 107 is at or below a minimum temperature (e.g., about 40° F. (about 4.5° C.) for a refrigerator compartment and about 32° F. (about 0° C.) for a freezer compartment required by the chilled/refrigerated items or the frozen items stored therein, the first storage compartment 105 and/or the second storage compartment 107 may be placed and kept (e.g., by a control signal) in a standby mode (e.g., low power or off) to conserve energy. Various temperature zones can be defined as chilled/refrigerated being between 0° C. and 5° C., frozen as being between −20° C. and 0° C., and ambient between 15° C. and 25° C.

On the other hand, when the temperature sensor 109a or 109b detects that the temperature in an interior of a respective one of the first and second storage compartments 105, 107 is above the minimum temperature required by the refrigerated items or the frozen items stored therein, the first storage compartment 105 and/or second storage compartment 107 may be switched (e.g., by a control signal) from the standby mode to an active cooling mode to bring the interior temperature of the first storage compartment 105 and/or second storage compartment 107 to (or below) the minimum temperature required by the refrigerated items or the frozen items.

In FIG. 1, the cart 100 includes at least one power source 113 (e.g., a power supply) and at least one power outlet 115 configured to provide (e.g., via a power strip) electrical power to the first storage compartment 105 and/or the second storage compartment 107 however, there may be more than one power source 113 and more than one power outlet 115. It will be appreciated that the locations of the power source 113 and the power outlet 115 are shown in FIG. 1 by way of example only, and that the power source 113 and power outlet 115 may be optional.

The pick cart 100 may have four wheels 104a-104d. To improve the maneuverability of the pick cart 100, the two rear wheels 104a and 104b may be swivel casters that permit the cart 100 to complete a full 360-degree rotation of the rear wheels 104a-104b. The two front wheels 104c and 104d may be directional lock casters, which include a locking mechanism (e.g., a stopper, a latch, etc.) that enables the cart 100 to lock the front wheels 104c-104d in any desired position (e.g., straight along the axis of movement of the cart 100), preventing the front wheels 104c and 104d from swiveling while locked. It should be understood that the front wheels 104c and 104d may be configured as swivel casters and/or the rear wheels 104a and 104b may be configured as directional lock casters.

The cart 100 may include one or more indicators 131 (such as one or more lights or other visual indicators) coupled to the frame 102 of the cart 100 and configured to turn on (or otherwise actuate) to indicate various types of information. The light 131 of the cart 100 may turn on (e.g., in a red color) to indicate a problem with one or more of the bags 220 or the items on the cart 100. The light 131 of the cart 100 may turn on (e.g., in a yellow color) to indicate to/instruct a worker to place a bag 220 or an item onto this cart 100 (instead of onto another cart 100 not having a yellow light 131 on at that time). The light 131 of the cart 100 may light up (e.g., in a green color) to indicate to a worker (or a customer who came to the product storage facility 200 to pick up an order) to remove a bag 220 or an item from this cart 100 (as opposed to another cart 100 not having a green light 131 on at that time).

Notably, the cart 100 does not have to include a light 131 to instruct the worker as to which of the carts 100 to place a bag 220 of items thereon. For example, each of the carts 100 may have a unique identifier (e.g., a number, a color, etc.), and the worker may be instructed (e.g., via an audible or visible instruction) to place a bag 220 (or remove the bag 220 from) a cart 100 associated with a specific unique identifier.

The cart 100 may include indicators (e.g., lights) 133a-133c, with light 133a being positioned adjacent a first support member 106a (i.e., top shelf), light 133b being positioned adjacent the second support member 106b (i.e., the middle shelf), and light 133c being positioned adjacent the third support member 106c (i.e., the bottom shelf). These lights 133a-133c are configured to be independently and selectively turned on (e.g., by a control signal via a local or remote-control circuit) to indicate to a worker of the product storage facility 200 a specific location where to place a bag 220 on the cart 100. For example, when the light 133a located adjacent the top support member 106a lights up, this serves as an instruction to the worker to place a bag 220 (or unbagged item) onto the top shelf of the cart 100 (since the items inside this bag 220 are ambient storage items). When the light 133c located adjacent to the third support member 106c lights up, this serves as an instruction to the worker to place a bag 220 (or an unbagged item) onto the bottom shelf of the cart 100 (e.g., into the first storage compartment 105 (since the items inside this bag 220 require refrigerated storage), or into the second storage compartment 107 (since the items inside this bag 220 require frozen storage)).

The cart 100 may include additional indicators (e.g., lights) 135 positioned along the support members 106a-106c adjacent to each physical location where a bag 220 may be placed. For example, if each of the support members 106a-106c is sized and shaped to accommodate four item-containing bags 220 thereon, such a support member 106a-106c may include four lights 135, each of which is located adjacent (e.g., below) the physical location where each one of the four bags 220 may be placed on the support member 106a-106c. For example, when a given light 135 adjacent to or on a given support member (e.g., shelf) 106a-106c lights up, that may serve as an instruction to a worker to place a bag 220 onto this support member 106a-106c (or into the first or second storage compartment 105 or 107) in a location indicated by the illuminated light 135. When a given light 135 of a given support member (e.g., shelf) 106a-106c lights up, that may serve as an instruction to a worker (or a customer who came to pick up an order) to remove a bag 220 located on this support member 106a-106c adjacent to the illuminated light 135.

The cart 100 may include one or more sensors 137 (e.g., weight sensors, cameras, etc.) to detect the placement of a bag 220 (or an unbagged item) onto a support member 106a-106c, or the placement of a bag 220 or an unbagged item into the refrigerator compartment 105, or the placement of a bag 220 or an unbagged item into the freezer compartment 107. By the same token, the sensors 137 may detect when a bag 220 (or an unbagged item) is removed from a support member 106a-106c, the refrigerator compartment 105, or the freezer compartment 107.

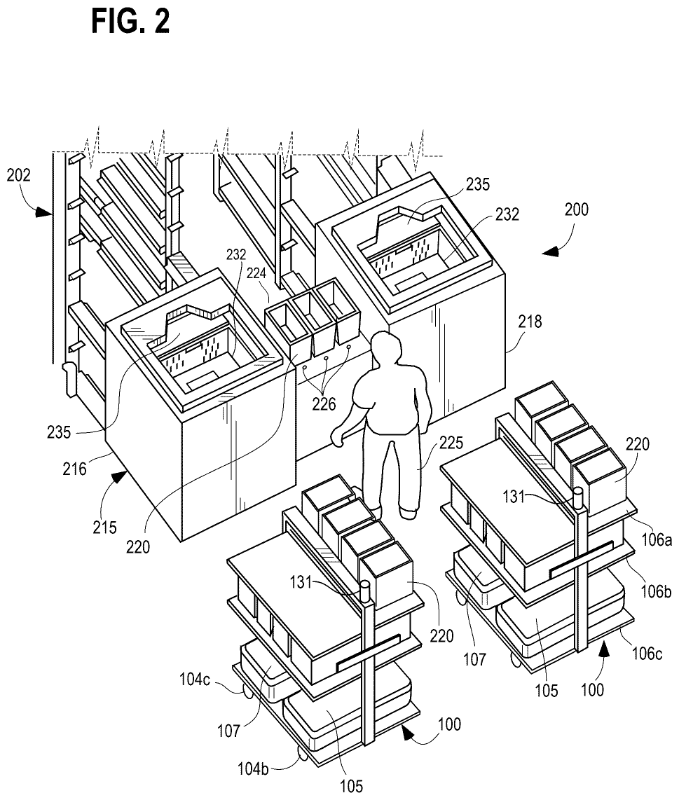

FIG. 2 shows a perspective view of an exemplary automated product storage facility 200 including a product storage structure 202, mobile robots 235, and a workstation 215. The exemplary workstation 215 is an order processing station, where products are picked (by the hand of a human operator or an arm of a robot) from totes 232 and placed into containers or bags 220 and/or onto one or more pick carts 100.

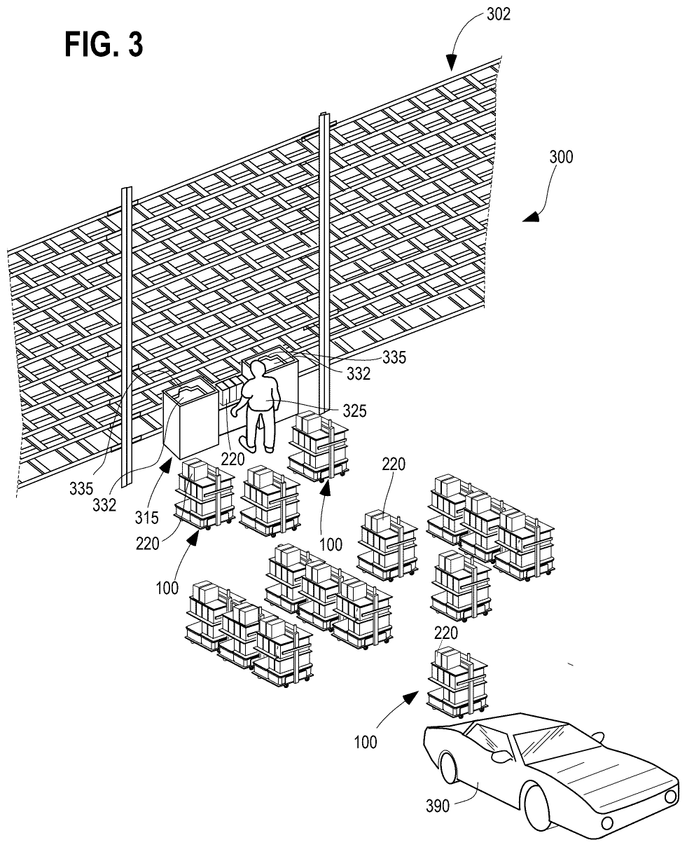

While FIG. 2 shows only two carts 100 at the workstation 215, there may be on cart 100, three carts 100 (as shown in FIG. 3), or more than three carts 100 may be located in proximity to the operator 225 at the workstation 215. It should be noted that the carts 100 according to the present disclosure described herein do not necessarily have to be used in conjunction with the automated product storage facility 200 or the product storage structure 202, but may be used at any facility, where products are stored and/or transported from one location to another.

As noted above, instead of a human operator 225 picking the products/goods from the totes 232 and placing the products/goods into the containers/bags 220 at the workstation 215, the workstation 215 may include a robot with one or more robotic arms for picking the products/goods from the totes 232 and placing the picked products/goods into the bags 220, such as disclosed, for example, in U.S. patent application Ser. No. 17/338,814, filed Jun. 4, 2021, and entitled “Robotic Each Picking in a Micro-Fulfillment Center,” which is hereby incorporated by reference in its entirety. As used herein, a product or products that may be ordered by consumers may be referred to as “a good” or “goods”, an individual product or good may be referred to as an “each”, and individual ones of the products or goods may be referred to as “eaches.”

In the workstation 215 shown in FIG. 2, the bagging station (also referred to herein as a “bagging area”) 224 is shown as having three side-by-side containers/bags 220 (although it will be appreciated that more or less bags 220 may be located at the bagging station 224 of the workstation 215). Notably, the bagging station 224 does not necessarily have to be located between the picking areas 216 and 218, and may be located in another suitable location that is within reach of the operator 225. The container/bags 220 in the bagging station 224 may be made of cardboard, or of any other suitable material such as plastic, and may have sizes and shapes different from the exemplary containers/bags 220 shown in FIG. 2. As such, the bagging station 224 may store various types of bags 220 (e.g., plastic bags, paper bags, cloth bags, single use bags, multi-use bags, tote liners, etc.) instead of simply storing three identical bags 220 as illustrated in FIG. 2. Notably, while the exemplary bags 220 illustrated in FIG. 2 are not shown with handles, it will be appreciated that any of the bags 220 described herein may include handles that facilitate easier carrying of the bags 220 by the user.

In FIG. 2, the mobile robots 235 are shown as having brought the totes 232 to the picking areas 216 and 218, respectively of the workstation 215. The exemplary bagging area 224 of the workstation 215 is shown as being located between the tote presentation locations/picking areas 216 and 218, respectively, of workstation 215. The bags 220 may be automatically pre-loaded into the bagging area 224 at picking areas 216 and 218 via an optional container dispenser, for example, such as described in U.S. patent application Ser. No. 17/884,345, which is entitled “Container to Tote Dispense Integrated With Automated Storage and Retrieval System,” which is hereby incorporated by reference in its entirety.

Eaches (i.e., individual products) are sequentially picked by the operator 225 from product tote(s) 232 on either or both picking areas 216, 218, after which the picked caches are placed by the operator 225 into one or more bags 220 that are located at the bagging station 224 of the workstation 215. The operator 225 of the workstation 215 may be free to arbitrarily pick caches from the product tote(s) 232 and/or to keep adding the caches picked from the product tote(s) 232 to the container(s)/bag(s) 220 at the bagging station 224 in conjunction with order fulfillment until the operator 225 deems the container(s)/bag(s) 220 to be full however, the determination of which bag 220 to place the product(s) removed from a tote 232 into may be made by a computer instead of the operator 225. The operator 225 may then remove the container(s)/bag(s) 220 from the bagging station 224 and transfer such container(s)/bag(s) 220 onto a cart 100 arbitrarily chosen by the operator 225.

As noted above, the determination of which bag 220 to place the product(s) removed from a tote 232 into may be made by a computer instead of the operator 225. For example, the bagging station 224 may include indicators (e.g., lights) 226 positioned adjacent each one of the bags 220 located in the bagging area 224, such that an indicator 226, when illuminated, indicates to the operator 225 the bag 220 into which to place the caches picked by the operator 225 from a product tote 232 located in picking areas 216, 218. For example, when a light 226 located adjacent to (e.g., under) a bag 220 in the bagging area 224 lights up, that may serve as an instruction to the operator 225 to either place the item picked from a tote 232 into that bag 220, or to remove this bag 220 from the bagging station 224 and place this bag 220 on a cart 100. For example, if the indicator 226 located adjacent to a bag 220 in the bagging area 224 lights up yellow, that may serve as an instruction to the operator 225 to place the item picked from a tote 232 into that bag 220. If the indicator 226 located adjacent to a bag 220 in the bagging area 224 lights up green, that may serve as an instruction to the operator 225 to remove this bag 220 from the bagging station 224 and place this bag 220 on a cart 100.

One or more cameras or other suitable sensors may be positioned at the bagging area 224 (e.g., above the bags 220), such that the determination of when a bag 220 at the bagging area 224 is sufficiently full of caches is made not by the operator 225, but by a control circuit communicatively coupled to the camera(s) or sensor(s).

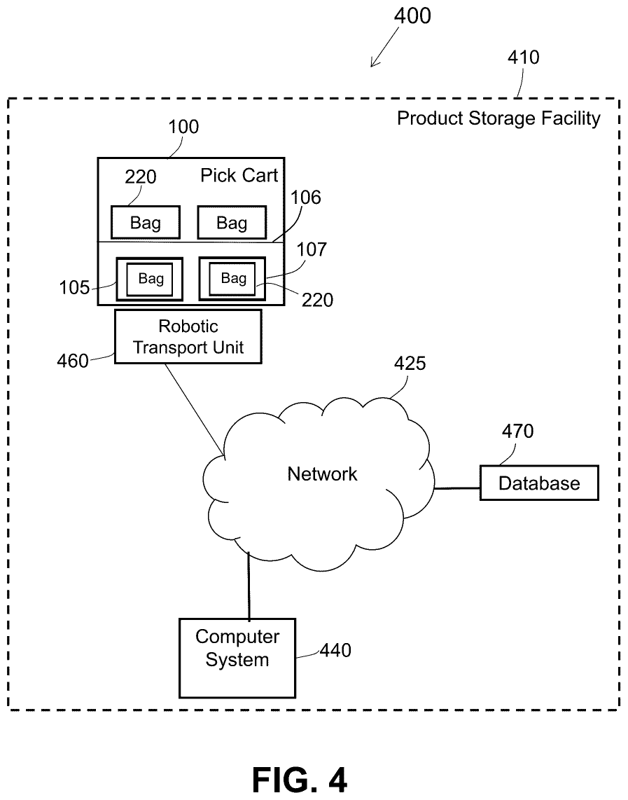

After each bag 220 is filled with caches picked from the totes 232, the operator 225 may remove the container(s)/bag(s) 220 from the bagging station 224 and transfer such container(s)/bag(s) 220 onto a cart 100 arbitrarily chosen by the operator 225, or chosen by a computer. As will be discussed in more detail below, the cart 100 may be wirelessly directed and/or guided by a computer system 440 (see FIG. 4) directly, or via a motorized transport unit 460, to move toward the workstation 215 and into the position shown in FIG. 2. By the same token, the cart 100 may be wirelessly directed and/or guided by a computer system 440 (see FIG. 4) directly, or via a motorized transport unit 460, to move away from the workstation 215 toward the product storage structure, or to move toward a product pick up area and adjacent a car 390 of a customer, as shown in FIG. 3.

The loading of the carts 100 by the operator 225 may be controlled by a remote computing system (e.g., computing system 440 shown in FIG. 4). For example, if a product that requires refrigeration storage or freezer storage arrives in a tote 232 to the workstation 215, the control circuit 510 of the computing system 440 (which will be discussed in more detail below) may determine whether this product is designated for pick-up by a customer from the product storage facility 200 within three hours of the arrival of the product at the workstation 215.

If the answer is no (e.g., if the control circuit 510 of the computing system 440 determines that the customer will be picking up this product in 4 hours, 6 hours, 12 hours, etc.), the control circuit 510 of the computing device 440 transmits a control signal to the workstation 215 to cause the tote 232 to return to the storage structure 202. The product then stays at the storage structure 202 in refrigerated or frozen storage as appropriate, but when the pick-up time of the order containing this refrigerated/frozen product by the customer is less than 3 hours away, the product is brought via a tote 232 back to the workstation 215 for picking and placement onto a cart 100.

On the other hand, if the answer is yes (e.g., if the control circuit 510 determines that the customer will be picking up this product in 1 hour, 2 hours, etc.), the control circuit 510 of the computing device 440 transmits a control signal to the workstation 215 to instruct the operator 225 to pick the refrigerated/frozen product from the tote 232 and to place it (e.g., while in the interior of a bag 220) into the refrigerator compartment 105 or into the freezer compartment 107 of the cart as appropriate. After the refrigerated or frozen product is loaded by the operator 225 onto the cart 100, the cart 100 or a motorized transport unit 460 coupled to the cart 100 may be guided wirelessly by a computer system 440 away from the workstation 215 and toward a cart holding area (e.g., coral) located in a product pick up area and/or toward a car 390 of a customer. In one aspect, the cart 100 is configured to be switched to a manual mode by a worker of the product storage facility 200 either at the workstation 215 or at the cart holding area to enable the worker to manually guide the cart to a desired destination (e.g., cart holding area or car 390 of a customer).

As mentioned above, each cart 100 may include an indicator 131 (in the illustrated exemplary embodiment, a light) coupled to the frame 102 of the cart 100 and configured to turn on (e.g., in a pre-selected color) to indicate that a given one of the bags 220 filled with caches at the bagging station 224 is to be loaded onto the cart 100. In other words, when a light 131 on one of the carts 100 located adjacent the workstation 215 lights up, this serves as an indication (instruction) to the worker that the bag 220 located at the bagging station 224 is to be placed onto the cart 100 having its light 131 on at that time.

A cart 100 for placement of a full bag 220 therein may be selected (e.g., by a control circuit of a computing device in communication with the cart 100) based on a first item of an order that arrives at the workstation 215, and the light 131 of the selected cart 100 is caused to light up (e.g., responsive to a control signal sent by the control circuit of the computing device in communication with the cart 100). A control signal from a computing device in communication with the cart 100 may direct the cart 100 to a workstation 215.

Notably, the carts do not have to include a light 131 to instruct the worker as to which of the carts 100 to place a bag 220 of items thereon. For example, each of the carts 100 may have a unique identifier (e.g., a number, a color, etc.), and the worker may be instructed (e.g., via an audible or visible instruction) to transfer a bag 220 from the bagging station 224 onto the cart 100 associated with a specific unique identifier.

After all bags 220 are transferred from the bagging station 224 onto their respective cart 100 and/or after the cart 100 has no space to store any more bags 220 or bagless products thereon, the full carts 100 containing the bags 220 filled with products (e.g., ambient products, chilled, frozen products) may be guided (e.g., via robotic transport units 460, the operator 225, another worker, a rail, etc.) to a storage area (e.g., a cart coral or an order pickup area), where a worker of the product storage facility 200 (or a customer who placed an order) may remove the bag(s) 220 containing the customer-ordered items from the cart 100 (or pick one or more of the customer-ordered products from the bag(s) 220 on the cart 100). As mentioned above, when a light 131 of a cart 100 lights up, this may serve as an instruction to a worker (or a customer picking up an order) to remove a bag 220 located on cart 100 with the lit-up light 131.

After the operator 225 picks the caches from the product totes 232 on either or both picking areas 216 and 218 of the workstation 215, instead of placing the picked caches into the bags 220 located at the bagging station 224 of the workstation 215, the operator 225 may place the picked caches directly onto a cart 100 located adjacent the workstation 215. After the operator 225 picks the caches from the product totes 232 on either or both picking areas 216 and 218 of the workstation 215, instead of placing the picked caches into the bags 220 located at the bagging station 224 of the workstation 215, the operator 225 may place the picked caches into bags 220 that are preloaded onto carts 100 located at the workstation 215.

Notably, instead of being placed onto the carts 100 by a worker 225 at the workstation 215, the bags 220 located on the carts 100 may be automatically pre-loaded into the carts 100 via a bag dispenser, such as disclosed in U.S. patent application Ser. No. 17/884,345, filed Aug. 9, 2022, and entitled “Container to Tote Dispense Integrated With Automated Storage and Retrieval System,” incorporated by reference herein in its entirety. Then, the carts 100 pre-loaded with bags 220 containing the products associated with the customer orders being picked up by the customers may move (e.g., via robotic transport units 460, the operator 225, another worker, a rail, etc.) to an order pickup area, where a worker or a customer may remove the bags 220 (or pick the products out of the bags 220) from the cart 100.

As mentioned above, the cart 100 may include a light 131. The light 131 may be configured to turn on (e.g., in response to a control signal sent by a control circuit 510 of a computing device 440) to indicate to a worker to place an unbagged item picked from the operator 225 into a bag 220 that has been pre-loaded onto the cart 100 (instead of into a bag 220 of another cart 100 not having a light 131 on at that time).

As also mentioned above, the cart 100 may include lights 133a-133c. These lights 133a-133c may be configured to be independently and selectively turned on (e.g., by a control signal sent to the cart 100 by a control circuit 510 of the computing device 440) to indicate to a worker of the product storage facility 200 a location on the cart (e.g., top support member (e.g., shelf) 106a, middle support member (e.g., shelf) 106b, refrigerator compartment 105, freezer compartment 107, etc.) where a bag 220 into which the unbagged item should be placed is positioned. For example, when the light 133a located adjacent to the top support member 106a lights up, this serves as an instruction to the worker that the bag 220 into which a given ambient storage item is to be placed is located on the top support member 106a.

As mentioned above, the cart 100 may include additional lights 135 positioned along the support members 106a-106c. In one aspect, when a support member 106a-106c (e.g., a middle shelf 106b of cart 100) is sized and shaped to accommodate four pre-loaded bags 220 thereon, the support member 106b may include four lights 135, each of which is located adjacent (e.g., below) the physical location where each one of the four pre-loaded bags 220 are located on the support member 106b. For example, when the left-most light 135 adjacent to the middle shelf 106b lights up, that serves as an instruction to a worker to place an item into the left-most bag 220 located on the middle shelf 106b.

The cart 100 may include one or more sensors 137 (e.g., weight sensors, cameras, etc.) to detect the placement of an unbagged item into a bag 220 preloaded onto a support member (e.g., shelf) 106a-106c, or into the refrigerator compartment 105, or into the freezer compartment 107 of the cart 100. By the same token, the sensors 137 may detect when an item is removed from a bag 220 located on a support member 106a-106c, or in the refrigerator compartment 105, or in the freezer compartment 107.

FIG. 3 shows a perspective view of an automated product storage facility 300 including a product storage structure 302, mobile robots 335 configured to move about the product storage structure 302 while transporting totes 332 and to bring the totes 332 to one or more workstations 315. At the exemplary workstations 315, products/goods may be picked (by the hand of a human operator 325 or by a movable component of a robotic device) from totes 332 and placed into bags 220, which may be located at the workstations 315 and/or onto one or more pick carts 100, which may be located adjacent the workstations 315, or stored (if needed, in a nested condition to save storage space) nearby the workstations 315. In FIG. 3, one pick cart 100 is shown next to a vehicle 390 of a customer to show that the pick cart 100 may be moved by the operator 325 (or via a robotic transport unit or another suitable method) from the workstation 315 to another location inside or outside of the product storage facility 300.

A non-transitory program storage device readable by a machine may be provided, such as memory, for example, tangibly embodying a program of instructions executable by the machine for performing operations as described in connection with the various embodiments disclosed herein. Any combination of one or more computer readable medium(s) may be utilized as the memory. The computer readable medium may be a computer readable signal medium or a non-transitory computer readable storage medium.

A non-transitory computer readable storage medium does not include propagating signals and may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

FIG. 4 shows an embodiment of a system 400 implemented in whole or in part at a product storage facility 410 (such as those described above) for facilitating the movement of carts 100 that store product-containing bags 220 thereon (e.g., on one or more support members (e.g., shelves) 106, in a refrigerated compartment 105, and/or in a freezer compartment 107 thereof). Generally, as shown in FIG. 4, the system 400 includes pick carts 100 configured to store and move bags 220 that contain one or more retail products, as well as one or more robotic transport units 460 configured to mechanically engage (and, optionally, disengage a respective pick cart 100), a computer system 440 in two-way communication with the robotic transport units 460, a database 470, and a network 425. It will be understood that the system 400 is shown in FIG. 4 by way of example only, and more or fewer of such components may be included in different embodiments of the system 400. For example, in some aspects, the system 400 may include a location detection system configured to detect the physical location of each cart 100 at the product storage facility 410 at any given time.

The product storage facility 410 may be any facility (e.g., warehouse, stock room of a store, product sorting facility, product distribution facility, or the like) where products are stored and/or sold. While the present disclosure refers to bags 220 in the context of the objects being moved around on the carts 100, it will be appreciated that the objects moved on the carts 100 do not necessarily have to be in bags 220 and may be moved around on a cart 100 while in containers other than bags 220 (e.g., boxes, bins, packages, or the like) or while bagless. The pick carts 100 may be moved around the product storage facility 410 for general order fulfillment purposes, and/or loading/unloading purposes.

The robotic transport units 460 are located at the product storage facility 410 and are configured to move throughout the space of the product storage facility 410 and to mechanically engage and disengage the pick carts 100, as described in more detail below. The robotic transport units 460 are configured to selectively and detachably couple to a corresponding pick cart 100 that is configured to support one or more bags 220 thereon. Each (or one or more of the) robotic transport unit(s) 460 may be non-detachably coupled to (e.g., integrally incorporated into) the physical structure of the pick cart 100, such that the robotic transport unit 460 is not meant to detach from its respective cart 100. Examples of robotic transport units 460 configured to mechanically attach to and detach from pick carts 100 and exemplary pick carts 100 with integrated robotic transport units 460 are described, for example, in U.S. Provisional Patent App. No. 63/602,225, filed Nov. 22, 2023 and entitled “Direct to Bag Pick Carts for Use at Product Storage Facilities,” which is hereby incorporated by reference in its entirety.

The robotic transport units 460 do not require the presence of, or physical operation by, a human operator and wirelessly communicate with, and are wholly or largely controlled by, the computer system 440. The computer system 440 is configured to control the movement of the robotic transport units 460 through the product storage facility 410 (e.g., toward or away from a workstation 215, toward or away from a car 390 of a customer, etc.) based on a variety of inputs, control signals, etc. For example, the computer system 440 communicates with each robotic transport unit 460 via the network 425, which may be one or more wireless networks of one or more wireless network types (such as a wireless local area network, a wireless personal area network, a wireless mesh network, a wireless star network, a wireless wide area network, a cellular network, and so on), capable of providing wireless coverage of the desired range of the robotic transport units 460 according to any known wireless protocols, including but not limited to a cellular, Wi-Fi, Zigbee or Bluetooth network.

The exemplary computer system 440 is in two-way communication with the robotic transport unit 460 via the network 425. In some aspects, the computer system 440 is configured to transmit at least one signal to one or more robotic transport units 460 to cause the robotic transport units 460 to move toward, engage with, control, disengage from, and/or move away from their respective pick carts 100 to facilitate the transport of bagless products or products in bags 220 throughout the product storage facility 410. The computer system 440 may be configured to transmit at least one signal to a cart 100 to cause one or more lights 131, 133, and/or 135 to light up to provide an instruction or indication to a worker or a customer as described above.

The exemplary computer system 440 may be a stationary or portable electronic device, for example, a desktop computer, a laptop computer, a tablet, a mobile phone, or any other electronic device including a processor-based control circuit. In FIG. 4, the computer system 440 is configured for data entry and processing as well as for communication with other devices (e.g., robotic transport units 460) of the system 400 via the network 425 which may be a wide-area network (WAN), a local area network (LAN), a personal area network (PAN), a wireless local area network (WLAN), or any other internet or intranet network, or combinations of such networks. The computer system 440 may be located at the same location as the robotic transport units 460 (i.e., at the product storage facility 410), or at a location remote to the robotic transport units 460 (e.g., a central or regional data storage facility).

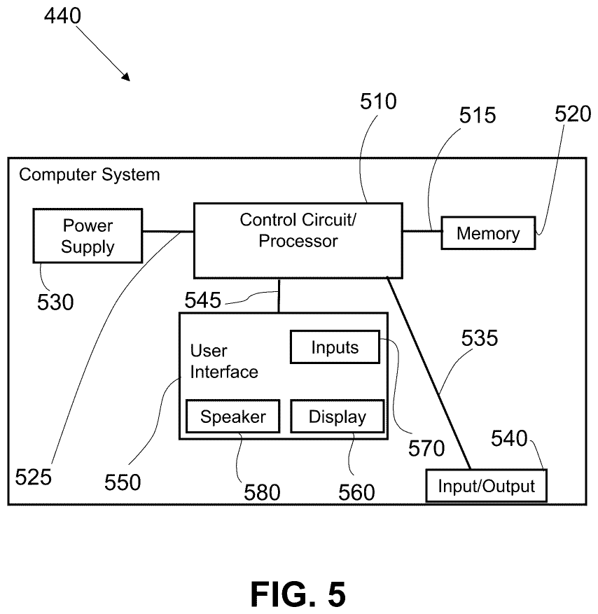

With reference to FIG. 5, the computer system 440 configured for use with exemplary systems and methods described herein may include a control circuit 510 including a processor (e.g., a microprocessor or a microcontroller) electrically coupled via a connection 515 to a memory 520 and via a connection 525 to a power supply 530. The control circuit 510 can comprise a fixed-purpose hard-wired platform or can comprise a partially or wholly programmable platform, such as a microcontroller, an application specification integrated circuit, a field programmable gate array, and so on. These architectural options are well known and understood in the art and require no further description here.

This control circuit 510 can be configured (for example, by using corresponding programming stored in the memory 520 as will be well understood by those skilled in the art) to carry out one or more of the steps, actions, and/or functions described herein. In some embodiments, the memory 520 may be integral to the processor-based control circuit 510 or can be physically discrete (in whole or in part) from the control circuit 510 and is configured non-transitorily store the computer instructions that, when executed by the control circuit 510, cause the control circuit 510 to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM)) as well as volatile memory (such as an erasable programmable read-only memory (EPROM))). Accordingly, the memory and/or the control circuit may be referred to as a non-transitory medium or non-transitory computer readable medium.

The control circuit 510 of the computer system 440 is electrically coupled via a connection 535 to an input/output 540 (e.g., wireless interface) that can receive wired or wireless signals from one or more of the robotic transport units 460. The input/output 540 of the computer system 440 can send signals to the robotic transport units 460 indicating which location at the product storage facility 410 and/or which worker at the product storage facility 410 to move toward and/or which pick cart 100 to move toward and/or couple to, where to move the pick cart 100, and/or where to drop off the pick cart 100.

With reference to FIG. 5, an exemplary computer system 440 may include a processor-based control circuit 510 electrically coupled via a connection 545 to a user interface 550, which may include a visual display or display screen 560 (e.g., LED screen) and/or button input 570 that provide the user interface 550 with the ability to permit an operator of the computer system 440, such as a worker at the product storage facility 410 where the system 400 is implemented, to manually control the computer system 440 by inputting commands via touch-screen and/or button operation and/or voice commands to, for example, to send a signal to a robotic transport unit 460.

Such a signal sent by the computer system 440 may instruct the robotic transport unit 460 to: move toward and adjacent to a specific pick cart 100 selected by the computer system 440 and to couple to the pick cart 100; uncouple from and move away from a pick cart 100; control movement of a pick cart 100 by virtue of controlling the movement of a robotic transport unit 460 coupled to the pick cart 100 to cause the pick cart 100 to move toward a specific physical location (e.g., see FIG. 3, workstation 315, car 390 of a customer, etc.) and/or toward a specific worker at the product storage facility 410. In some aspects, such a signal sent by the computer system 440 may control movement of a pick cart 100 that is not coupled to a detachable robotic transport unit 460 (i.e., a pick cart 100 which may have its own wireless transceiver, processor-based control circuit, and built-in locomotion system). It will be appreciated that the performance of such functions by the processor-based control circuit 510 of the computer system 440 is not dependent on actions of a human operator, and that the control circuit 510 may be programmed to perform such functions without being actively controlled by a human operator. The user interface 550 may also include a speaker 580 in some aspects.

With continued reference to FIG. 5, the display screen 560 of the computer system 440 may be configured to display various graphical interface-based menus, options, and/or alerts that may be transmitted from and/or to the computer system 440 in connection with various aspects of moving pick carts 100 around the product storage facility 410 on their own or via the robotic transport units 460. The inputs 570 of the computer system 440 may be configured to permit an operator to navigate through the on-screen menus on the computer system 440 and make changes and/or updates to the routes and destinations of the robotic transport units 460 and/or pick carts 100 at the product storage facility 410. It will be appreciated that the display screen 560 may be configured as both a display screen and an input 570 (e.g., a touch-screen that permits an operator to press on the display screen 560 to enter text and/or execute commands.)

The computer system 440 may automatically generate a travel route for one or more pick carts 100 and/or robotic transport units 460 through the space of the product storage facility 410. This route may be based on a location of a robotic transport unit 460 and/or a pick cart 100 and/or the intended destination of robotic transport unit 460 and/or pick cart 100 and/or locations of structures/obstacles at the product storage facility 410. The computer system 440 may calculate multiple possible optimum routes.

The system 400 may correlate 2D and 3D maps of the product storage facility 410 with physical locations of objects at the product storage facility 410. Once the computer system 440 maps all objects to specific locations using algorithms, measurements and geo-location, grids may be applied to a map to designate access ways and blocked paths for the pick carts 100. Robotic transport units 460 may use these grids for navigation and object recognition. In some aspects, such grids may be applied to 2D maps along with 3D models.

With reference back to FIG. 4, the computer system 440 may be configured to access at least one database 470 over a network 425. The computer system 440 and the database 470 may be implemented as separate physical devices as shown in FIG. 4 (which may be at one physical location or two separate physical locations) or may be implemented as a single device at the product storage facility 410 (or at a location remote to the product storage facility 410). The database 470 may be stored, for example, on non-volatile storage media (e.g., a hard drive, flash drive, or removable optical disk) internal or external to the computer system 440, or internal or external to computing devices distinct from the computer system 440. In some embodiments, the database 470 is cloud-based.

The exemplary database 470 of FIG. 4 may be configured to store electronic data including, but not limited to: data associated with the products stored at the product storage facility 410, for example, location of origin of a product, destination of the product, storage requirements for the product (e.g., an indication whether a product is a product that requires storage at ambient, refrigerated/cooled, or freezer temperature), special instructions for the product, orders associated with the product, etc.; data associated with the pick carts 100 being used to store and/or move the products (e.g., location of a pick cart 100, destination of the pick cart 100, destination of a robotic transport unit 460 coupled to, moving toward, or moving away from a pick cart 100, identification of bags 220 and/or products on pick cart 100, etc.); data associated with the robotic transport units 460 being used to control movement of the pick carts 100 (e.g., location of each robotic transport unit 460, identification of the cart 100 being controlled by the robotic transport unit 460, route assigned to the robotic transport unit 460, etc.); and/or data associated with the computer system 440 (e.g., data transmitted by or to the computer system 440, data relating to the tracking and/or routing of movement of the robotic transport units 460 and/or pick carts 100, etc.).

As mentioned above, the system 400 may optionally include a location detection system for purposes of providing input to the computer system 440 to enable the computer system 440 to determine the location of one or more of the robotic transport units 460 within the space of the product storage facility 410. For example, a location detection system may include a series of light sources (e.g., LEDs (light-emitting diodes)) that are mounted at known positions (e.g., in the ceiling) throughout the space of the product storage facility 410 and that each encodes data in the emitted light that identifies the source of the light (and thus, the location of the light). As a given robotic transport unit 460 or a pick cart 100 moves through the space of the product storage facility 410, light sensors (or light receivers) on the robotic transport unit 460 and/or on the pick cart 100 being transported by the robotic transport unit 460 may receive the light and can decode the data. This data may be sent back to the computer system 440, which can determine the position of the robotic transport unit 460 and/or of the pick cart 100 by the data it receives in real-time, since the computer system 440 is able to relate the light data to a mapping of the light sources to known locations at the product storage facility 410.

The optional location detection system may include a series of radio beacons (e.g., Bluetooth low energy beacons) at known positions throughout the space of the product storage facility 410 that encode data in the emitted radio signal that identifies the beacon (and thus, the location of the beacon). As a robotic transport unit 460 and/or pick cart 100 moves through the space of the product storage facility 410, low energy receivers of the robotic transport unit 460 and/or of the pick cart 100 being transported by the robotic transport unit 460 may receive the radio signal and decode the data. This data is sent back to the computer system 440 which determines the position of the robotic transport unit 460 and/or pick cart 100 by the location encoded in this radio signal, since the computer system 440 is able to relate the received location data to a mapping of the radio beacons to locations at the product storage facility 410.

The optional location detection system may include a series of audio beacons at known positions throughout the space of the product storage facility 410 that encode data in the emitted audio signal that identifies the beacon (and thus, the location of the beacon). As a given robotic transport unit 460 and/or pick cart 100 moves through the space, microphones on the robotic transport unit 460 and/or pick cart 100 being transported by the robotic transport unit 460 receive the audio signal and can decode the data. This data is sent back to the computer system 440, which can determine the position of the robotic transport unit 460 and/or pick cart 100 by the location encoded in the audio signal it receives in real-time, since the computer system 440 can relate the location data to a mapping of the audio beacons to known locations at the product storage facility 410.

Each (or one or more) of the robotic transport units 460 and/or the pick carts 100 may include a global positioning system (GPS) tracking devices that permit a GPS-based identification of the location of the robotic transport units 460 and/or the pick carts 100 in real-time by the computer system 440. The optional location detection system of the system 400 may include one or more video cameras, and video imagery captured by the video cameras may be provided to the computer system 440. This information can then serve, for example, to help the computer system 440 determine the present location of one or more of the robotic transport units 460 and/or determine issues or concerns regarding the movement of the robotic transport units 460 at the product storage facility 410. For example, such information may permit the computer system 440 to detect an object in a path of movement of a robotic transport unit 460.

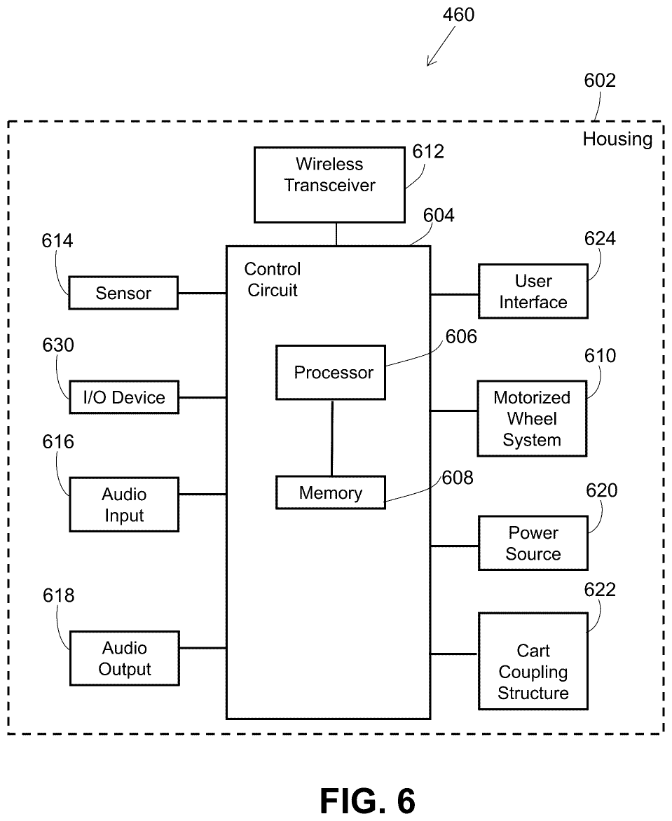

FIG. 6 presents a detailed schematic example of the robotic transport unit 460 of FIG. 4. In this example, the robotic transport unit 460 has a housing 602 that contains (partially or fully) or at least supports and carries a number of components. These components include a control circuit 604 comprising a processor 606 that, like the control circuit 510 of the computer system 440, may control the general operations of the robotic transport unit 460. Accordingly, the control circuit 604 also includes a memory 608 coupled to the processor 606 and that stores, for example, operating instructions and/or useful data.

The control circuit 604 operably couples to a motorized wheel system 610. This motorized wheel system 610 functions as a locomotion system to permit the robotic transport unit 460 to move within the product storage facility 410 (thus, the motorized wheel system 610 may more generically be referred to as a locomotion system). Generally, this motorized wheel system 610 will include at least one drive wheel (i.e., a wheel that rotates (around a horizontal axis) under power to thereby cause the robotic transport unit 460 to move through interaction with, for example, the floor of the product storage facility 410). The motorized wheel system 610 can include any number of rotating wheels and/or other floor-contacting mechanisms as may be desired and/or appropriate to the application setting. The motorized wheel system 610 may also include a steering mechanism of choice. One simple example may include one or more wheels that can swivel about a vertical axis to thereby cause the moving robotic transport unit 460 to turn as well. Various examples of motorized wheel systems are known in the art. Further elaboration in these regards is not provided here for the sake of brevity save to note that the aforementioned control circuit 604 is configured to control the various operating states of the motorized wheel system 610 to thereby control when and how the motorized wheel system 610 operates.

In FIG. 6, the control circuit 604 operably couples to at least one wireless transceiver 612 that operates according to any known wireless protocol. This wireless transceiver 612 can comprise, for example, a Wi-Fi-compatible and/or Bluetooth-compatible transceiver that can wirelessly communicate with the computer system 440 via the network 425 as shown in FIG. 4. So configured, the control circuit 604 of the robotic transport unit 460 can provide information to the computer system 440 (e.g., via the network 425) and can receive information and/or movement instructions from the computer system 440.

The control circuit 604 can receive instructions from the computer system 440 regarding directional movement (e.g., specific predetermined routes of movement) of the robotic transport unit 460 when coupled to a pick cart 100 throughout the space of the product storage facility 410. These teachings will accommodate using any of a wide variety of wireless technologies as desired and/or as may be appropriate in a given application setting. These teachings will also accommodate employing two or more different wireless transceivers 612, if desired.

In FIG. 6, the control circuit 604 couples to one or more on-board sensors 614. These teachings will accommodate a wide variety of sensor technologies and form factors. By one approach, at least one such sensor 614 can comprise a light sensor or light receiver. When the optional location detection system mentioned above comprises a plurality of light emitters disposed at particular locations within the product storage facility 410, such a light sensor 614 can provide information that the control circuit 604 and/or the computer system 440 may employ to determine a present location and/or orientation of the robotic transport unit 460 within the space of the product storage facility 410.

Such a sensor 614 can comprise a distance measurement unit configured to detect a distance between the robotic transport unit 460 and one or more objects or surfaces around the robotic transport unit 460 (such as an object that lies in a projected path of movement for the robotic transport unit 460 through the product storage facility 410). These teachings will accommodate any of a variety of distance measurement units including optical units and sound/ultrasound units. A sensor 614 may comprise a laser distance sensor device that determines a distance to objects in proximity to the sensor. A sensor 614 may comprise an optical scanning device to sense/read optical patterns in proximity to the sensor 614.

A sensor 614 comprises a radio frequency identification (RFID) tag reader capable of reading RFID tags in proximity to the sensor. Such sensors may be useful to determine proximity to nearby objects, avoid collisions, orient the robotic transport unit 460 at a proper alignment orientation to engage, for example, a pick cart 100 or the like. The foregoing examples are intended to be illustrative and are not intended to convey an exhaustive listing of all possible sensors. Instead, it will be understood that these teachings will accommodate sensing any of a wide variety of circumstances or phenomena to support the operating functionality of the robotic transport unit 460 in a given application setting.

A robotic transport unit 460 may detect objects along its path of travel using, for example, sensors mounted on robotic transport unit 460 and/or video cameras or other sensors/readers installed at the product storage facility 410, and/or sensors installed on the robotic transport unit 460, and/or via communications with the computer system 440. The robotic transport unit 460 may attempt to avoid obstacles, and if unable to avoid, it will notify the computer system 440 of such a condition. Using sensors 614 (e.g., distance measurement unit such as laser or other optical-based distance measurement sensors), the robotic transport unit 460 may detect and avoid obstacles in its path, or stop until the obstacle is clear.

By one optional approach, an audio input 616 (such as a microphone) and/or an audio output 618 (such as a speaker) can also operably couple to the control circuit 604. So configured, the control circuit 604 can provide a variety of audible sounds to thereby communicate with a worker or a customer at the product storage facility 410, or with other robotic transport units 460 at the product storage facility 410. These audible sounds can include any of a variety of tones and other non-verbal sounds. Such audible sounds can also include, in lieu of the foregoing or in combination therewith, pre-recorded or synthesized speech.

The audio input 616, in turn, provides a mechanism whereby, for example, a worker and/or a customer may provide verbal input to the control circuit 604. That verbal input can comprise, for example, instructions, inquiries, or information. For example, a worker may direct an instruction and/or query to the robotic transport unit 460. The control circuit 604 can cause the verbalized question to be transmitted to the computer system 440 via the wireless transceiver 612 of the robotic transport unit 460. The computer system 440 can process the verbal input to recognize the speech content and then determine an appropriate response. Such a response may comprise, for example, transmitting back to the robotic transport unit 460 specific instructions regarding how to move (i.e., a specific route calculated by the computer system 440) to the location in the product storage facility 410 where a given pick cart 100 is located.

In in FIG. 6, the robotic transport unit 460 includes a rechargeable power source 620 such as one or more batteries. The power provided by the rechargeable power source 620 can be made available to whichever components of the robotic transport unit 460 require electrical energy. When the robotic transport unit 460 is coupled to a pick cart 100, the power provided by the rechargeable power source 620 can be made available to one or more power sources 113 and/or one or more power outlets 115 of the pick cart 100 (or vice versa), which in turn provide power to the first storage compartment 105 and/or the second storage compartment 107 of the pick cart 100. By one approach, the robotic transport unit 460 includes a plug or other electrically conductive interface that the control circuit 604 can utilize to automatically connect to an external source of electrical energy to thereby recharge the rechargeable power source 620.

Where the robotic transport unit 460 is configured to detachably attach to and detach from a pick cart 100, the robotic transport unit may include a pick cart coupling structure 622 configured to operably couple to a pick cart 100 such that the robotic transport unit 460 is enabled to control directional movements of the pick cart 100 while operably coupled to the pick cart 100 via the pick cart coupling structure 622. As mentioned above, the robotic transport unit 460 may non-detachably attached to the pick cart 100 and comprises an integral part of the pick cart 100. As used herein, this reference to “integral” will be understood to refer to a non-temporary combination and joinder that is sufficiently complete so as to consider the combined elements to be as one. Such a joinder can be facilitated in a number of ways including by securing the robotic transport unit housing 602 to the pick cart 100 using bolts or other threaded fasteners as versus, for example, a clip.

The robotic transport unit 460 may include an input/output (I/O) device 630 that is coupled to the control circuit 604. The I/O device 630 allows an external device to couple to the control circuit 604. The function and purpose of connecting devices will depend on the application. Devices connecting to the I/O device 630 may add functionality to the control circuit 604, allow the exporting of data from the control circuit 604, allow the diagnosing of the robotic transport unit 460, and so on.

The robotic transport unit 460 may include a user interface 624 including, for example, user inputs and/or user outputs or displays depending on the intended interaction with the user (e.g., worker at product storage facility 410). For example, user inputs could include any input device such as buttons, knobs, switches, touch-sensitive surfaces or display screens, and so on. Example user outputs include lights, display screens, and so on. The user interface 624 may work together with or separate from any user interface implemented at a user interface unit (e.g., smartphone, tablet, etc.) used by a worker at the product storage facility 410.

The robotic transport unit 460 may be controlled by a user on-site, off-site, or anywhere in the world. This is due to the architecture of some embodiments where the computer system 440 outputs the control signals to the robotic transport unit 460. These controls signals can originate at any electronic device in communication with the computer system 440. For example, the movement signals sent to the robotic transport unit 460 may be movement instructions determined by the computer system 440; commands received at a user interface unit (in communication with the control circuit 604) from a user; and commands received at the computer system 440 from a remote user not located at the product storage facility 410.

The control circuit 604 includes a memory 608 coupled to the processor 606 and that stores, for example, operating instructions and/or useful data. The control circuit 604 can comprise a fixed-purpose hard-wired platform or can comprise a partially or wholly programmable platform. These architectural options are well known and understood in the art and require no further description here. This control circuit 604 is configured (for example, by using corresponding programming stored in the memory 608 as will be well understood by those skilled in the art) to carry out one or more of the steps, actions, and/or functions described herein.

The memory 608 may be integral to the control circuit 604 or can be physically discrete (in whole or in part) from the control circuit 604 as desired. This memory 608 can also be local with respect to the control circuit 604 (where, for example, both share a common circuit board, chassis, power supply, and/or housing) or can be partially or wholly remote with respect to the control circuit 604. This memory 608 can serve, for example, to non-transitorily store the computer instructions that, when executed by the processor 606, cause the control circuit 604 to behave as described herein. Notably, not all components illustrated in FIG. 6 are included in all embodiments of the robotic transport unit 460. In other words, some components illustrated in FIG. 6 may be optional depending on the implementation.

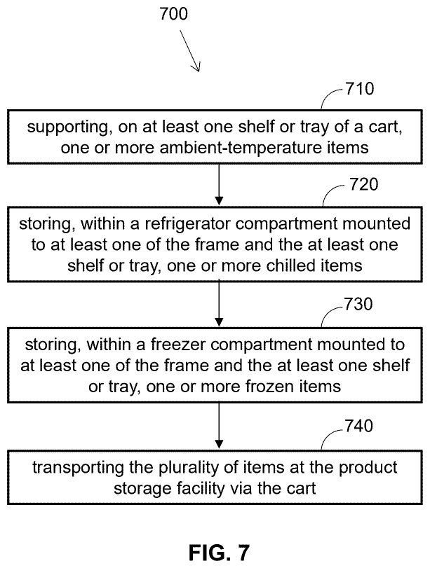

FIG. 7 shows an exemplary method 700 of transporting a plurality of items at a product storage facility 200 via a cart 100 that includes wheels 104a-104d mounted to and supporting a frame 102. The method includes supporting, on at least one support member (e.g., shelf or tray) 106a-106c of a cart 100, one or more ambient-temperature items, which, as mentioned above, may be placed directly onto the support member 106a-106c or into bags 220 that are then placed directly on to the shelf or tray (step 710).

The method 700 further includes storing, within a refrigerator compartment 105 mounted to at least one of the frame 102 and the at least one support member (e.g., shelf or tray) 106a-106c, one or more chilled items (step 720). As mentioned above, the refrigerator compartment 105 may be non-detachably mounted only to the frame 102, only to the support member 106a-106c, or to both the frame 102 and the support member 106a-106c.

The method 700 further includes storing, within a freezer compartment 107 mounted to at least one of the frame 102 and the at least one support member (e.g., shelf or tray) 106a-106c, one or more frozen items (step 730). As mentioned above, the freezer compartment 105 may be non-detachably mounted only to the frame 102, only to the support member 106a-106c, or to both the frame 102 and the support member 106a-106c.

Finally, the exemplary method 700 further includes transporting the plurality of items at the product storage facility 200 via the cart 100 (step 740).

The following are provided in accordance with the present disclosure and may be employed individually, in any combination with each other, and/or in any combination with the features described above:

A cart for transporting a plurality of items at a product storage facility comprises: a frame; wheels mounted to and supporting the frame; at least one support member mounted to the frame and configured to support ambient-temperature items thereon; a refrigerator compartment mounted to at least one of the frame and the at least one support member and configured to store chilled items therein; and a freezer compartment mounted to at least one of the frame and the at least one support member and configured to store frozen items therein.

The cart may include one or more of the following, employed individually or in any combination: the at least one support member is configured to support a plurality of bags containing the ambient-temperature items therein; the refrigerator compartment and the freezer compartment are non-detachably mounted to at least one of the frame and the at least one support member; at least one power source configured to provide electrical power to at least one of the refrigerator compartment and the freezer compartment; each of the refrigerator compartment and the freezer compartment includes a temperature sensor, and wherein each of the refrigerator compartment and the freezer compartment is configured to be: in standby mode when the temperature sensor detects that a temperature in an interior of a respective one of the refrigerator compartment and the freezer compartment is at or below a minimum temperature required by the chilled items or the frozen items, and in active cooling mode when the temperature sensor detects that the temperature in the interior of the respective one of the refrigerator compartment and the freezer compartment is above the minimum temperature required by the chilled items or the frozen items; the cart includes a first light coupled to the frame and configured to turn on to indicate that a given one of the items is to be loaded onto the cart; the first light is configured to turn on to indicate that the given one of the items is to be removed from the cart; the cart includes a plurality of second lights, each of the second lights being positioned adjacent a respective one of the at least one support member, the refrigerator compartment and the freezer compartment, and wherein one of the second lights is configured to turn on to indicate whether the given one of the items is to be loaded onto the at least one support member, into the refrigerator compartment, or into the freezer compartment; the cart is configured to be coupled to a robotic transport unit including a processor-based control circuit and configured to: mechanically engage the cart and to move the cart about the product storage facility when mechanically engaged to the cart, and mechanically disengage from the cart and to move toward and mechanically engage a second cart for moving the second cart about the product storage facility; and the robotic transport unit includes a transceiver configured to receive a control signal that causes the control circuit to cause movement of the wheels of the cart and navigate the cart to a destination indicated in the control signal.

A method for transporting a plurality of items at a product storage facility via a cart that includes wheels mounted to and supporting a frame comprises: supporting, on at least one support member of a cart, one or more ambient-temperature items; storing, within a refrigerator compartment mounted to at least one of the frame and the at least one support member, one or more chilled items; storing, within a freezer compartment mounted to at least one of the frame and the at least one support member, one or more frozen items; and transporting the plurality of items at the product storage facility via the cart.

The method may include one or more of the following, employed individually or in any combination: the refrigerator compartment and freezer compartment are non-detachably mounted to at least one of the frame and the at least one support member; providing electrical power to at least one of the refrigerator compartment and the freezer compartment via at least one power source; each of the refrigerator compartment and the freezer compartment includes a temperature sensor, and further comprising: keeping the refrigerator compartment or the freezer compartment in standby mode when the temperature sensor detects that a temperature in an interior of a respective one of the refrigerator compartment and the freezer compartment is at or below a minimum temperature required by the chilled items or the frozen items, and switching the first storage compartment or the second storage compartment to active cooling mode when the temperature sensor detects that the temperature in the interior of the respective one of the refrigerator compartment and the freezer compartment is above the minimum temperature required by the chilled items or the frozen items; turning on a first light coupled to the frame of the cart in a first color to indicate that one of the items is to be loaded onto the cart; turning on the first light in a second color to indicate that one of the items is to be removed from the cart; providing the cart with a plurality of second lights, each of the second lights being positioned adjacent a respective one of the at least one support member, the refrigerator compartment and the freezer compartment, and wherein one of the second lights is configured to turn on to indicate whether a given one of the items is to be loaded onto the at least one support member, into the refrigerator compartment, or into the freezer compartment; providing a robotic transport unit including a processor-based control circuit and, by the robotic transport unit, and mechanically engaging the cart to move the cart about the product storage facility when mechanically engaged to the cart, and mechanically disengaging from the cart to move toward and mechanically engage a second cart for moving the second cart about the product storage facility; and providing the robotic transport unit with a transceiver configured to receive a control signal that causes the control circuit to cause movement of the wheels of the cart and navigate the cart to a destination indicated in the control signal.

A method for transporting a plurality of items at a product storage facility comprises: transporting the plurality of items at the product storage facility via a cart, the cart including: a frame; wheels mounted to and supporting the frame; at least one support member mounted to the frame and configured to support ambient-temperature items thereon; a refrigerator compartment mounted to at least one of the frame and the at least one support member and configured to store chilled items therein; and a freezer compartment mounted to at least one of the frame and the at least one support member and configured to store frozen items therein.

It should be understood that the foregoing description is only illustrative of the present disclosure. Various alternatives and modifications can be devised by those skilled in the art without departing from the present disclosure. Accordingly, the present disclosure is intended to embrace all such alternatives, modifications and variances that fall within the scope of any claims appended hereto. Further, the mere fact that different features are recited in mutually different dependent or independent claims does not indicate that a combination of these features cannot be advantageously used, such a combination remaining within the scope of the present disclosure.

1. A cart for transporting a plurality of items at a product storage facility, the cart comprising:
a frame;
wheels mounted to and supporting the frame;
at least one support member mounted to the frame and configured to support ambient-temperature items thereon;
a refrigerator compartment mounted to at least one of the frame and the at least one support member and configured to store chilled items therein; and
a freezer compartment mounted to at least one of the frame and the at least one support member and configured to store frozen items therein.

2. The cart of claim 1, wherein the at least one support member is configured to support a plurality of bags containing the ambient-temperature items therein.

3. The cart of claim 1, wherein the refrigerator compartment and the freezer compartment are non-detachably mounted to at least one of the frame and the at least one support member.

4. The cart of claim 3, further comprising at least one power source configured to provide electrical power to at least one of the refrigerator compartment and the freezer compartment.

5. The cart of claim 3, wherein each of the refrigerator compartment and the freezer compartment includes a temperature sensor, and wherein each of the refrigerator compartment and the freezer compartment is configured to be:
in standby mode when the temperature sensor detects that a temperature in an interior of a respective one of the refrigerator compartment and the freezer compartment is at or below a minimum temperature required by the chilled items or the frozen items; and
in active cooling mode when the temperature sensor detects that the temperature in the interior of the respective one of the refrigerator compartment and the freezer compartment is above the minimum temperature required by the chilled items or the frozen items.

6. The cart of claim 1, wherein the cart includes a first light coupled to the frame and configured to turn on to indicate that a given one of the items is to be loaded onto the cart.

7. The cart of claim 6, wherein the first light is configured to turn on to indicate that the given one of the items is to be removed from the cart.

8. The cart of claim 6, wherein the cart includes a plurality of second lights, each of the second lights being positioned adjacent a respective one of the at least one support member, the refrigerator compartment and the freezer compartment, and wherein one of the second lights is configured to turn on to indicate whether the given one of the items is to be loaded onto the at least one support member, into the refrigerator compartment, or into the freezer compartment.

9. The cart of claim 1, wherein the cart is configured to be coupled to a robotic transport unit including a processor-based control circuit and configured to:
mechanically engage the cart and to move the cart about the product storage facility when mechanically engaged to the cart; and
mechanically disengage from the cart and to move toward and mechanically engage a second cart for moving the second cart about the product storage facility.

10. The cart of claim 9, wherein the robotic transport unit includes a transceiver configured to receive a control signal that causes the control circuit to cause movement of the wheels of the cart and navigate the cart to a destination indicated in the control signal.

11. A method for transporting a plurality of items at a product storage facility via a cart that includes wheels mounted to and supporting a frame, the method comprising:
supporting, on at least one support member of a cart, one or more ambient-temperature items;
storing, within a refrigerator compartment mounted to at least one of the frame and the at least one support member, one or more chilled items;
storing, within a freezer compartment mounted to at least one of the frame and the at least one support member, one or more frozen items; and
transporting the plurality of items at the product storage facility via the cart.

12. The method of claim 11, wherein the refrigerator compartment and freezer compartment are non-detachably mounted to at least one of the frame and the at least one support member.

13. The method of claim 12, further comprising providing electrical power to at least one of the refrigerator compartment and the freezer compartment via at least one power source.

14. The method of claim 12, each of the refrigerator compartment and the freezer compartment includes a temperature sensor, and further comprising:
keeping the refrigerator compartment or the freezer compartment in standby mode when the temperature sensor detects that a temperature in an interior of a respective one of the refrigerator compartment and the freezer compartment is at or below a minimum temperature required by the chilled items or the frozen items; and
switching the first storage compartment or the second storage compartment to active cooling mode when the temperature sensor detects that the temperature in the interior of the respective one of the refrigerator compartment and the freezer compartment is above the minimum temperature required by the chilled items or the frozen items.

15. The method of claim 11, further comprising turning on a first light coupled to the frame of the cart in a first color to indicate that one of the items is to be loaded onto the cart.

16. The method of claim 15, further comprising turning on the first light in a second color to indicate that one of the items is to be removed from the cart.

17. The method of claim 15, further comprising providing the cart with a plurality of second lights, each of the second lights being positioned adjacent a respective one of the at least one support member, the refrigerator compartment and the freezer compartment, and wherein one of the second lights is configured to turn on to indicate whether a given one of the items is to be loaded onto the at least one support member, into the refrigerator compartment, or into the freezer compartment.

18. The method of claim 11, further comprising:
providing a robotic transport unit including a processor-based control circuit and, by the robotic transport unit:
mechanically engaging the cart to move the cart about the product storage facility when mechanically engaged to the cart; and
mechanically disengaging from the cart to move toward and mechanically engage a second cart for moving the second cart about the product storage facility.

19. The method of claim 18, further comprising providing the robotic transport unit with a transceiver configured to receive a control signal that causes the control circuit to cause movement of the wheels of the cart and navigate the cart to a destination indicated in the control signal.

20. A method for transporting a plurality of items at a product storage facility, the method comprising:
transporting the plurality of items at the product storage facility via a cart, the cart including:
a frame;
wheels mounted to and supporting the frame;
at least one support member mounted to the frame and configured to support ambient-temperature items thereon;
a refrigerator compartment mounted to at least one of the frame and the at least one support member and configured to store chilled items therein; and
a freezer compartment mounted to at least one of the frame and the at least one support member and configured to store frozen items therein.
